(19) United States
(12) Patent Application Publication
(10) Pub. No.: US 2016/0172115 A1
(43) Pub. Date: Jun. 16, 2016

(54) CONDUCTIVE PASTE AND CAPACITOR ELEMENT CONSTITUTING SOLID ELECTROLYTIC CAPACITOR USING THE SAME

(71) Applicant: Murata Manufacturing Co., Ltd., Nagaokakyo-shi (JP)

(72) Inventor: AKIHIRO NOMURA, Nagaokakyo-shi (JP)

(21) Appl. No.: 15/052,064

(22) Filed: Feb. 24, 2016

Related U.S. Application Data
(63) Continuation of application No. PCT/JP2014/070699, filed on Aug. 6, 2014.

(30) Foreign Application Priority Data
Sep. 13, 2013 (JP) 2013-190413

(51) Int. Cl. H01G 9/042; H01B 1/16; H01G 9/15

(52) U.S. Cl. CPC H01G 9/042; H01G 9/15; H01B 1/16

(57) ABSTRACT

A capacitor element that includes a valve metal base, and an insulating layer, a solid electrolyte layer, a carbon layer and an electrode layer sequentially formed in one of two parts of the valve metal base which has a larger area, the parts being separated from each other by the insulating layer. For forming the electrode layer, an electrostatic coating method is used to apply a conductive paste. The conductive paste including at least a conductive filler, a thermosetting resin containing a phenoxy resin, and a curing agent.

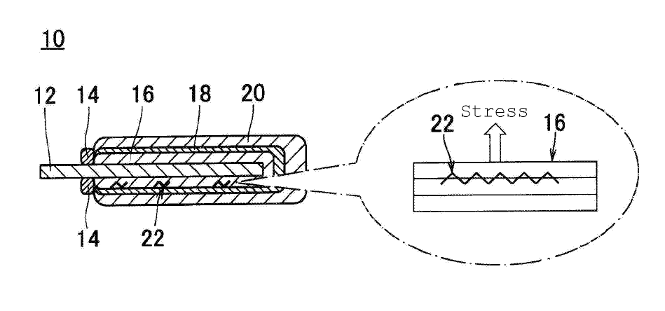

### CROSS REFERENCE TO RELATED APPLICATIONS

The present application is a continuation of International application No. PCT/JP2014/070699, filed Aug. 6, 2014, which claims priority to Japanese Patent Application No. 2013-190413, filed Sep. 13, 2013, the entire contents of each of which are incorporated herein by reference.

### FIELD OF THE INVENTION

The present invention relates to a conductive paste for use in an electrostatic coating method and a capacitor element constituting a solid electrolytic capacitor using the conductive paste, and particularly to a conductive paste for forming an electrode layer on a capacitor body having a solid electrolyte layer with the use of an electrostatic coating method, and a capacitor element constituting a solid electrolytic capacitor using the conductive paste.

### BACKGROUND OF THE INVENTION

A solid electrolytic capacitor is known which includes an anode body composed of a valve metal, wherein a dielectric oxide film layer, a solid electrolyte layer and a cathode layer partially composed of a silver layer are sequentially formed on the surface of the anode body. Here, the silver layer is composed of 95% or more of a flaky silver powder, a phenol novolak type epoxy resin and/or a tris-hydroxyphenyl-metal type epoxy resin, with the flaky silver power constituting 50 to 90% of the silver layer in terms of volume.

In such a solid electrolytic capacitor, stress at the time of curing the epoxy resin used for the silver layer is high, so that contact pressure with the flaky silver powder increases, thereby making it possible to reduce the resistance value of the silver layer and to improve adhesion with the solid electrolyte layer or other cathode layers. Consequently, a solid electrolytic capacitor excellent in equivalent series resistance (ESR) and impedance characteristics can be obtained (see Patent Document 1).

Patent Document 1: Japanese Patent Laid-open Publication No. 2004-165423

### SUMMARY OF THE INVENTION

Examples of the above-mentioned solid electrolytic capacitor include one having a solid electrolyte layer formed by chemical polymerization. Chemical polymerization is performed by, for example, repeating multiple times an operation including immersing in a monomer solution an aluminum foil having an oxide film layer, and then immersing the aluminum foil in an oxidant solution to polymerize a monomer. The solid electrolyte layer thus obtained has a multilayer structure in which interlayer peeling easily occurs under stress.

When a conductive paste for preparing a silver layer to be formed on the solid electrolytic capacitor of Patent Document 1 is used in formation of an electrode layer on the solid electrolyte layer, stress at the time of curing the conductive paste may cause interlayer peeling in the solid electrolyte layer, leading to generation of cracks in the solid electrolyte layer. When cracks are generated in the solid electrolyte layer, ESR characteristics of the solid electrolytic capacitor are deteriorated.

Accordingly, a main object of the present invention is to provide a conductive paste capable of providing a capacitor element constituting a solid electrolytic capacitor having good ESR characteristics.

Further, another object of the present invention is to provide a capacitor element constituting a solid electrolytic capacitor having good ESR characteristics by using the conductive paste of the present invention.

The present invention provides a conductive paste used for forming an electrode of a capacitor element constituting a solid electrolytic capacitor, the conductive paste including at least a conductive filler, a thermosetting resin containing a phenoxy resin, and a curing agent, and used for forming an electrode by an electrostatic coating method.

The phenoxy resin has a higher molecular weight than an epoxy resin or the like, and has small shrinkage at the time of curing. Use of such a conductive paste containing a thermosetting resin containing a phenoxy resin can reduce stress applied to a solid electrolyte layer at the time of forming an electrode. Therefore, generation of cracks in the solid electrolyte layer can be prevented, so that a capacitor element constituting a solid electrolytic capacitor having good ESR characteristics can be obtained.

In addition, the shrinkage at the time of curing is increased as the thickness of the conductive paste is increased. In this regard, the use of an electrostatic coating method can apply the conductive paste on the solid electrolyte layer to have a small and uniform thickness. The reduced thickness of the conductive paste can further reduce the stress, cracks can be thus prevented from being generated, and a capacitor element can be obtained which has favorable ESR characteristics.

In the conductive paste, the molecular weight of the phenoxy resin is preferably 15000 to 100000.

When the molecular weight of the phenoxy resin contained in the conductive paste is small, shrinkage at the time of curing may increase so that large stress may be applied to the solid electrolyte layer. By using a phenoxy resin having a molecular weight of 15000 to 100000, a solid electrolytic capacitor having good ESR characteristics can be obtained.

The total content of the phenoxy resin and the curing agent in such an amount as to react with the phenoxy resin, in the total of the thermosetting resin and the curing agent in such an amount as to react with the thermosetting resin, is preferably 1% by mass or more.

When the content of the phenoxy resin is small, the effect of reducing shrinkage at the time of curing the thermosetting resin may no longer be obtained so that large stress may be applied to the solid electrolyte layer. By ensuring that the total content of the phenoxy resin and the curing agent in such an amount as to react with the phenoxy resin, in the total of the thermosetting resin and the curing agent in such an amount as to react with the thermosetting resin, is 1% by mass or more, a solid electrolytic capacitor having good ESR characteristics can be obtained.

Further, the content of the conductive filler in the solid content of the conductive paste is preferably 70 to 97% by mass.

When the content of the conductive filler is small, the amount of the thermosetting resin increases, and therefore shrinkage at the time of curing the conductive paste may increase so that large stress may be applied to the solid electrolyte layer. When the content of the conductive filler is large, and the amount of the thermosetting resin is excessively small, the shrinkage ratio of the conductive paste may decrease to increase the distance between conductive filler particles, leading to a reduction in conductivity of the electrode layer obtained. By using a conductive paste having a conductive filler content of 70 to 97% by mass, a capacitor element having good ESR characteristics can be obtained.

Further, the present invention provides a capacitor element constituting a solid electrolytic capacitor, including a valve metal base, a solid electrolyte layer formed on the valve metal base, and an electrode layer formed on the solid electrolyte layer, wherein the electrode layer is formed by an electrostatic coating method using the conductive paste described above.

By forming an electrode layer using the above-mentioned conductive paste, a capacitor element that is free from generation of cracks in a solid electrolyte layer and has good ESR characteristics can be obtained.

According to the present invention, a capacitor element constituting a solid electrolytic capacitor having good ESR characteristics can be obtained.

The above-mentioned objects, other objects, features and advantages of the present invention will become more apparent from the following description with reference to the drawing.

### BRIEF EXPLANATION OF THE DRAWING

The FIGURE is an illustration showing one example of a capacitor element constituting a solid electrolytic capacitor of the present invention.

### DETAILED DESCRIPTION OF THE INVENTION

The FIGURE is an illustration showing one example of a capacitor element constituting a solid electrolytic capacitor of the present invention. A capacitor element 10 includes a valve metal base 12. As the valve metal base 12, for example, a chemically converted aluminum foil is used. The chemically converted aluminum foil has a dielectric oxide film formed on the periphery of an aluminum foil, and is used as an anode element. Here, the dielectric oxide film can be formed by chemically converting the surface of an aluminum foil using an aqueous ammonium adipate solution or the like.

An insulating layer 14 is formed at a predetermined distance from one end of the valve metal base 12. The insulating layer 14 is formed in a belt shape so as to make one round of the valve metal base 12. A solid electrolyte layer 16 is formed by, for example, chemical polymerization in one of two parts of the valve metal base 12, which has a larger area, the parts being separated from each other by the insulating layer 14. The solid electrolyte layer 16 is formed by repeating a process multiple times, the process including immersing a chemically converted aluminum foil in a monomer solution, and then immersing the chemically converted aluminum foil in an oxidant solution. Since the solid electrolyte layer 16 is formed by such chemical polymerization, the solid electrolyte layer 16 has a multilayer structure. For forming the solid electrolyte layer 16, for example, a conductive polymer of polythiophene can be used.

A carbon layer 18 is formed on the solid electrolyte layer 16. The carbon layer 18 is formed by applying a carbon paste onto the solid electrolyte layer 16 and drying the carbon paste. As the carbon paste, for example, one made of carbon particles, a resin, a solvent and so on can be used. Examples of the carbon particles include graphite and carbon black. Examples of the resin include polyesters, phenols and epoxies. The solvent is not particularly limited, and examples thereof include acetate-based solvents, carbitol-based solvents and water.

An electrode layer 20 as a cathode layer is formed on the carbon layer 18. The electrode layer 20 is formed by applying a conductive paste onto the carbon layer 18 and drying the conductive paste.

In this regard, a conductive paste is applied with the use of an electrostatic coating method.

The electrostatic coating method refers to a method of filling, with a paste-like coating material, a discharge nozzle for discharging the coating material, applying a voltage between the discharge nozzle and an object to be coated, and discharging the charged paste material from the discharge nozzle, thereby applying the charged paste material.

When the paste material is discharged from the discharge nozzle, the charged paste material flies in the air along lines of electric force from the nozzle to the object to be coated. During this period, the paste material repeats fission (Rayleigh fission) due to Coulomb repulsion, and thus turns into microparticles in adhering to the surface of the object to be coated. Therefore, the paste material can be applied to the surface of the object to be coated.

In addition, the particle surface area of the paste material is increased each time the Rayleigh fission is repeated, thus accelerating the volatilization of solvent component in the paste material. As a result, the paste material is, in adhering to the surface of the object to be coater, dried to the extent that the fluidity is almost lost, almost without any surface tension applied. Therefore, the variation in thickness due to the surface tension of the solvent component is not caused, but the paste material can be applied uniformly to the surface of the object to be coated.

In the case of applying the paste material with the use of this method, the stability of the application is affected by the charging efficiency of the paste material, the amounts of the conductive filler and solvent in the paste material, and furthermore, the paste viscosity, etc.

As the conductive paste for forming the electrode layer 20, a paste made of a conductive filler, a thermosetting resin containing a phenoxy resin, a curing agent, a diluent, a curing accelerator and so on is used. As the conductive filler, a flaky, spherical, or amorphous silver powder may be used. The ratio of the conductive filler in the solid content of the conductive paste is set to be 70 to 97% by mass. The solid content is the remainder of the conductive paste after a volatile component (solvent) is removed from the conductive paste.

As the thermosetting resin, for example, a cresol novolak type epoxy resin and a phenoxy resin are used. Besides, a phenol novolak type epoxy resin, a bisphenol type epoxy resin and the like can be used. The phenoxy resin is a polyhydroxy polyether synthesized from a bisphenol and epichlorohydrin, and has a weight average molecular weight (Mw) of 15000 or more.

As the curing agent for the epoxy resin and the phenoxy resin, for example, a phenol resin is used.

As the diluent, for example, dipropylene methyl ether acetate or the like is used. Besides, an organic solvent such as a carbitol-based solvent can be used. As the curing accelerator, for example, a tertiary amine-based curing accelerator and an imidazole-based curing accelerator are used.

The electrode layer 20 is formed on the carbon layer 18 using the above-mentioned conductive paste. Here, since the insulating layer 14 is formed, a short-circuit between the valve metal base 12 and the electrode layer 20 is prevented.

The epoxy resin for use in the conductive paste for forming the electrode layer 20 typically has a weight average molecular weight (Mw) of 2000 or less, whereas the phenoxy resin is a polyhydroxy polyether synthesized from a bisphenol and epichlorohydrin, which has weight average molecular weights (Mw) of 15000 to 100000, and examples thereof include bisphenol A and bisphenol F. As compared to a resin having a larger molecular weight, a resin having a smaller molecular weight has a larger shrinkage at the time of curing. Therefore, as compared with a conductive paste using only an epoxy resin as a thermosetting resin, the conductive paste blended with the phenoxy resin has a reduced shrinkage at the time of curing, and the stress applied to the solid electrolyte layer 16 is thus reduced. In the solid electrolyte layer 16 having a multilayer structure, interlayer peeling easily occurs under stress as shown in the FIGURE, while the conductive paste blended with the phenoxy resin can suppress microcracks 22 into the solid electrolyte layer 16.

When only an epoxy resin is used as the thermosetting resin, shrinkage at the time of curing the conductive paste increases, so that stress applied to the solid electrolyte layer 16 increases, leading to generation of microcracks in the solid electrolyte layer 16. Therefore, equivalent series resistance (ESR) characteristics of the capacitor element 10 are deteriorated.

Further, the ratio of the conductive filler in the solid content of the conductive paste is preferably 70 to 97% by mass. When the ratio of the conductive filler is less than 70% by mass, the ratio of the resin increases, so that stress applied to the solid electrolyte layer 16 at the time of curing the conductive paste increase, leading to deterioration of ESR characteristics. When the ratio of the conductive filler in the solid content of the conductive paste is more than 97% by mass, the ratio of the resin is decreased, thereby resulting in insufficient adhesion after the curing, and peeling is thus caused, leading to deterioration of ESR characteristics.

In addition, while silver, a silver-containing alloy, a copper powder, and the like can be used as the conductive filler, the silver or silver-containing alloy which is less likely to be oxidized in the atmosphere is stable in resistivity, and thus preferred for achieving favorable ESR characteristics.

By using the above-mentioned conductive paste, the electrode layer 20 can be formed without generating microcracks in the solid electrolyte layer 16, and the capacitor element 10 having good ESR characteristics can be obtained.

A solid electrolytic capacitor can be obtained by resistance-welding the exposed part of the valve metal base 12 of the obtained capacitor element 10 to an external connection terminal, bonding the electrode layer 20 as a cathode layer with another external connection terminal by a conductive adhesive, and performing sealing with an exterior resin in such a manner as to expose a part of these external connection terminals.

This conductive paste has low stress at the time of curing, and therefore the strength of the solid electrolyte layer is low, so that an excellent effect can be exhibited in a capacitor element in which a dielectric oxide film formed under the solid electrolyte layer is very thin.

### Example 1

As a valve metal base in a capacitor element, a chemically converted aluminum foil having a length of 3 mm in the minor axis direction, a length of 10 mm in the major axis direction and a thickness of 100 μm was used. For obtaining the chemically converted aluminum foil, a dielectric oxide film was formed so as to cover an aluminum foil, and the obtained chemically converted aluminum foil was used as an anode element. The dielectric oxide film was formed by chemically converting the surface of an aluminum foil using an aqueous ammonium adipate solution.

Next, at a predetermined distance from one end of the chemically converted aluminum film in the major axis direction, a belt-shaped insulating layer was formed so as to make one round of the chemically converted aluminum foil for preventing a short-circuit between an anode and a cathode. Thereafter, a solid electrolyte layer was formed in one of two parts of the chemically converted aluminum foil, which had a larger area, the parts being separated from each other by the insulating layer. At this time, the solid electrolyte layer was formed by repeating a process multiple times, the process including immersing a dielectric oxide film-formed surface of the chemically converted aluminum foil in a monomer solution, and then immersing the surface of the chemically converted aluminum foil in an oxidant solution. For obtaining the solid electrolyte layer, a conductive polymer of polythiophene was used.

Next, a carbon paste was applied onto the solid electrolyte layer, and dried to form a carbon layer. As the carbon paste, one made of carbon particles, a phenol resin and a carbitol-based organic solvent was used. The conductive paste was applied onto the obtained carbon layer, and dried to form an electrode layer.

The conductive paste was applied with the use of an electrostatic coating method.

The exposed part of the valve metal base of the capacitor element thus obtained was bonded to an external connection terminal by resistance welding, and the electrode layer was bonded to another external connection terminal by a conductive adhesive. Thereafter, sealing with an exterior resin was performed in such a manner as to expose a part of the external connection terminals to obtain a solid electrolytic capacitor.

The conductive paste for forming the electrode layer includes a flaky silver powder (D50=3.3 μm) as a conductive filler, a cresol novolak type epoxy resin (Mw=2000), a phenoxy resin, a phenol resin as a curing agent, an imidazole-based curing accelerator as a curing accelerator, and dipropylene methyl ether acetate as a diluent.

In each example and comparative example, the materials were mixed in the blending ratio shown in Table 1 to prepare a conductive paste.

To the compositions in Table 1, a solvent (dipropylene methyl ether acetate) was further added so as to allow stable application by an electrostatic coating method, and to provide a viscosity of 8 Pa·s or less at 1 rpm of an E-type viscometer.

TABLE 1

| | Blending ratio (% by mass) | | | | | |
|---|---|---|---|---|---|---|
| | Conductive filler | | | | | |
| | | Silver- | | | Curing | |
| | | coated | Thermosetting resin | | agent | Curing |
| | Silver | copper | Epoxy | Phenoxy | Phenol | accelerator |
| | powder | powder | resin | resin | resin | Imidazole |
| Example 1 | 91 | — | 4.2 | 2.6 | 2.1 | 0.1 |
| Example 2 | 91 | — | 4.2 | 2.6 | 2.1 | 0.1 |
| Example 3 | 91 | — | 4.2 | 2.6 | 2.1 | 0.1 |
| Example 4 | 91 | — | 4.2 | 2.6 | 2.1 | 0.1 |
| Example 5 | 91 | — | 4.2 | 2.6 | 2.1 | 0.1 |
| Example 6 | 91 | — | 4.2 | 2.6 | 2.1 | 0.1 |
| Example 7 | 91 | — | 6 | 0.1 | 2.8 | 0.1 |
| Example 8 | 91 | — | 5.7 | 0.4 | 2.8 | 0.1 |
| Example 9 | 91 | — | 5.4 | 0.9 | 2.6 | 0.1 |
| Example 10 | 91 | — | 4.8 | 1.8 | 2.3 | 0.1 |
| Example 11 | 91 | — | 3 | 4.4 | 1.5 | 0.1 |
| Example 12 | 91 | — | 0.6 | 7.9 | 0.4 | 0.1 |
| Example 13 | 97 | — | 1.4 | 0.9 | 0.6 | 0.1 |
| Example 14 | 95 | — | 2.3 | 1.5 | 1.1 | 0.1 |
| Example 15 | 80 | — | 9.3 | 5.9 | 4.6 | 0.2 |
| Example 16 | 75 | — | 11.7 | 7.3 | 5.8 | 0.2 |
| Example 17 | 70 | — | 14.1 | 8.8 | 6.9 | 0.2 |
| Example 18 | — | 91 | 4.2 | 2.6 | 2.1 | 0.1 |
| Comparative | 91 | — | 6 | — | 2.9 | 0.1 |
| Example 1 | | | | | | |

A cathode layer was formed on the carbon layer using the above-mentioned conductive paste. In this regard, the conductive paste was applied by an electrostatic coating method onto the carbon layer, and a heat treatment was performed at 200° C. for 60 minutes to form an electrode layer.

For the capacitor element thus obtained, the ESR was measured at 100 kHz using an LCR meter. At this time, the ESR was measured for 10 capacitor elements, and an average thereof was employed as a measurement result.

TABLE 2

| | Epoxy resin | | Phenoxy resin | | Filler | | |
|---|---|---|---|---|---|---|---|
| | component | | component | | component | | |
| | Molecular | Ratio in | Molecular | Ratio in | Ratio in | | |
| | weight | resin | weight | resin | electrode | Type of | ESR |
| | (Mw) | (%) | (Mw) | (%) | (%) | filler | (mohm) |
| Example 1 | 2000 | 70 | 50000 | 30 | 91 | Silver | 16 |
| | | | | | | powder | |
| Example 2 | 2000 | 70 | 15000 | 30 | 91 | Silver | 32 |
| | | | | | | powder | |
| Example 3 | 2000 | 70 | 30000 | 30 | 91 | Silver | 20 |
| | | | | | | powder | |
| Example 4 | 2000 | 70 | 40000 | 30 | 91 | Silver | 17 |
| | | | | | | powder | |
| Example 5 | 2000 | 70 | 60000 | 30 | 91 | Silver | 18 |
| | | | | | | powder | |
| Example 6 | 2000 | 70 | 100000 | 30 | 91 | Silver | 23 |
| | | | | | | powder | |
| Example 7 | 2000 | 99 | 50000 | 1 | 91 | Silver | 33 |
| | | | | | | powder | |
| Example 8 | 2000 | 95 | 50000 | 5 | 91 | Silver | 29 |
| | | | | | | powder | |
| Example 9 | 2000 | 90 | 50000 | 10 | 91 | Silver | 23 |
| | | | | | | powder | |
| Example 10 | 2000 | 80 | 50000 | 20 | 91 | Silver | 18 |
| | | | | | | powder | |
| Example 11 | 2000 | 50 | 50000 | 50 | 91 | Silver | 22 |
| | | | | | | powder | |
| Example 12 | 2000 | 10 | 50000 | 90 | 91 | Silver | 30 |
| | | | | | | powder | |
| Example 13 | 2000 | 69 | 50000 | 31 | 97 | Silver | 29 |
| | | | | | | powder | |
| Example 14 | 2000 | 69 | 50000 | 31 | 95 | Silver | 18 |
| | | | | | | powder | |
| Example 15 | 2000 | 70 | 50000 | 30 | 80 | Silver | 21 |
| | | | | | | powder | |
| Example 16 | 2000 | 70 | 50000 | 30 | 75 | Silver | 23 |
| | | | | | | powder | |
| Example 17 | 2000 | 70 | 50000 | 30 | 70 | Silver | 33 |
| | | | | | | powder | |
| Example 18 | 2000 | 70 | 50000 | 30 | 91 | Silver- | 21 |
| | | | | | | coated | |
| | | | | | | copper | |
| Comparative | 2000 | 100 | — | 0 | 91 | Silver | 50 |
| Example 1 | | | | | | powder | |

In Examples 1 to 6, the mass ratio of the epoxy resin component/the phenoxy resin component was 70/30, the content of the conductive filler in the solid content of the conductive paste was 91% by mass, and the weight average molecular weight (Mw) of the phenoxy resin was 50000, 15000, 30000, 40000, 60000 and 100000, respectively. In this regard, the mass ratio of the epoxy resin component/the phenoxy resin component being 70/30 means that the mass ratio of (epoxy resin+equivalent amount of curing agent)/(phenoxy resin+equivalent amount of curing agent) is 70/30, i.e. the ratio of the total of the phenoxy resin and the curing agent in such an amount as to react with the phenoxy resin to the total of the epoxy resin, the phenoxy resin and the curing agent in such an amount as to react therewith is 30% by mass. It is to be noted that the blending ratio of the imidazole compound was adjusted to 1% to the total amount of the epoxy resin and the phenoxy resin.

As can be seen from Examples 1 to 6, when the ratio of silver in the electrode is adjusted to 91% by mass, and when the phenoxy resin of 15000 to 100000 in weight average molecular weight (Mw) is blended in the resin of the conductive paste to account for 30% by mass, the shrinkage at the time of curing the conductive paste decreases to decrease the stress applied to the solid electrolyte layer. Therefore, without generating microcracks in the solid electrolyte layer, excellent ESR characteristics of 32 mohm or less have been succeeded in being obtained. It is to be noted that in this evaluation, the ESR can be determined to be favorable when the ESR is 40 mohm or less.

In addition, in Examples 7 to 12, as a result of preparing capacitor elements with the use of conductive pastes prepared in the same manner as in Example 1, except that a phenoxy resin of 50000 in weight average molecular weight (Mw) was blended in the resin of the conductive paste so as to account for 1% by mass, 5% by mass, 10% by mass, 20% by mass, 50% by mass, and 90% by mass, and measuring the ESR for the obtained capacitor elements, the shrinkage at the time of curing the conductive paste was reduced to reduce the stress applied to the solid electrolyte layer, thereby generating no microcrack in the solid electrolyte layer, and succeeding in achieving excellent ESR characteristics of 33 mohm or less.

In addition, in Examples 13 to 17, as a result of preparing capacitor elements with the use of conductive pastes prepared in the same manner as in Example 1, except that the content of the conductive filler in the solid content in the conductive paste was adjusted to 97% by mass, 95% by mass, 80% by mass, 75% by mass, and 70% by mass, and that a phenoxy resin of 50000 in weight average molecular weight (Mw) was blended in the resin of the conductive paste so as to account for 31, 31, 30, 30, and 30%, and measuring the ESR for the obtained capacitor elements, excellent ESR characteristics of 33 mohm or less have succeeded in being achieved.

In Example 18, as a result of preparing a capacitor element with the use of a conductive paste prepared in the same manner as in Example 1, except that a flaky silver-coated copper powder (D50=4.0 μm) was used, and that the content of the conductive filler in the solid content in the conductive paste was adjusted to 91% by mass, and measuring the ESR for the obtained capacitor element, excellent ESR characteristics have succeeded in being achieved.

Furthermore, as Comparative Example 1, a capacitor element was prepared using a conductive paste prepared in the same manner as in Example 1, except that the conductive paste did not contain a phenoxy resin, and the content of the conductive filler in the solid content of the conductive paste was adjusted to 91% by mass, and the ESR of the capacitor element obtained was measured.

In Comparative Example 1, a conductive paste that does not contain a phenoxy resin is used. Since this conductive paste did not contain a phenoxy resin having a high weight average molecular weight (Mw), stress at the time of curing the conductive paste increased, leading to generation of microcracks in the solid electrolyte layer, so that a capacitor element having good ESR characteristics was not able to be obtained.

From the results of measuring ESR characteristics using the examples and comparative example described above, it is determined that a capacitor element having excellent ESR characteristics can be obtained by using a conductive paste which contains a phenoxy resin having a weight average molecular weight (Mw) falling within a predetermined range and which includes a predetermine amount of a conductive filler.

### DESCRIPTION OF REFERENCE SYMBOLS

10 Capacitor element
12 Valve metal base
14 Insulating layer
16 Solid electrolyte layer
18 Carbon layer
20 Electrode layer
22 Microcrack

1. A conductive paste comprising:
a conductive filler;
a thermosetting resin containing a phenoxy resin; and
a curing agent.

2. The conductive paste according to claim 1, wherein the conductive filler is a silver powder.

3. The conductive paste according to claim 1, wherein a ratio of the conductive filler in a solid content of the conductive paste is 70 to 97% by mass.

4. The conductive paste according to claim 1, wherein the thermosetting resin includes a cresol novolak epoxy resin and the phenoxy resin.

5. The conductive paste according to claim 4, wherein the cresol novolak epoxy resin has a weight average molecular weight of 2000 or less, and the phenoxy resin has a weight average molecular weight of 15000 to 100000.

6. The conductive paste according to claim 4, wherein the curing agent is a phenol resin.

7. The conductive paste according to claim 1, wherein the curing agent is a phenol resin.

8. The conductive paste according to claim 1, further comprising a diluent, an organic solvent, and a curing accelerator.

9. The conductive paste according to claim 1, wherein the phenoxy resin has a weight average molecular weight of 15000 to 100000.

10. A solid electrolytic capacitor comprising:
a valve metal base,
a solid electrolyte layer on the valve metal base, and
an electrode layer on the solid electrolyte layer, wherein
the electrode layer is formed from the conductive paste according to claim 1.

11. The solid electrolytic capacitor according to claim 10, further comprising an insulating layer located at a predetermined distance from one end of the valve metal base so as to separate the one end of the valve metal base from the solid electrolyte layer.

12. The solid electrolytic capacitor according to claim 11, further comprising a carbon layer between the solid electrolyte layer and the electrode layer.
